(19) United States
(12) Patent Application Publication
(10) Pub. No.: US 2025/0145193 A1
(43) Pub. Date: May 8, 2025

(54) SYSTEM AND METHOD FOR INTELLIGENTLY DIFFUSING UNIT STORAGE ACROSS PARKING LOT RESOURCES TO MAXIMIZE UNIT THROUGHPUT IN A HUB BASED ON A DUAL-STREAM RESOURCE OPTIMIZATION

(71) Applicant: BNSF Railway Company, Fort Worth, TX (US)

(72) Inventors: Dasaradh R. Mallampati, Trophy Club, TX (US); Vishal Badyal, Haslet, TX (US); Paul Kuhn, Fort Worth, TX (US); April Y. Kuo, Colleyville, TX (US)

(73) Assignee: BNSF Railway Company, Fort Worth, TX (US)

(21) Appl. No.: 18/911,441

(22) Filed: Oct. 10, 2024

Related U.S. Application Data
(63) Continuation-in-part of application No. 18/501,608, filed on Nov. 3, 2023, now Pat. No. 12,217,199.

(51) Int. Cl. B61L 27/16; B61L 25/06

(52) U.S. Cl. CPC B61L 27/16; B61L 25/06

(57) ABSTRACT

Systems and techniques for intelligently diffusing units across parking lot resources of a hub based on a dual-stream resource optimization (DSRO). In embodiments, a unit diffusion manager intelligently diffuses or spreads units across the parking spots of a parking lot resource to which the units may be assigned based on unit characteristics to maximize unit throughput within the hub. The unit characteristics of a unit include a unit-train assignment identifying the outbound train to which the unit may be assigned, a train-track assignment of the outbound train identifying the production track to which the outbound train is assigned for loading the units onto the outbound train, an identification of the customer to which the unit belongs, and/or other characteristics that may be relevant to the movement of the unit within the hub.

### CROSS-REFERENCE TO RELATED APPLICATIONS

The present application is a continuation-in-part of pending and co-owned U.S. patent application Ser. No. 18/501,608, entitled “SYSTEMS AND METHODS FOR INTERMODAL DUAL-STREAM-BASED RESOURCE OPTIMIZATION”, filed Nov. 3, 2023, the entirety of which is herein incorporated by reference for all purposes.

### TECHNICAL FIELD

The present disclosure relates generally to resource optimization systems, and more particularly to systems and devices for intelligently diffusing unit storage across parking lot resources to maximize unit throughput in a hub based on a dual-stream resource optimization.

### BACKGROUND

Transportation hubs are essential to logistic operations. Transportation hubs enable the coordination for goods to be received, stored, sorted, and loaded for delivery to their destination. In particular, intermodal hub facilities (IHFs) function as critical junctures where units, typically containers bearing goods, are transitioned between different transportation modes including, but not limited to, rail, road, maritime, and aerial transport. These hubs are characterized by their capabilities to handle and process units that are designed for multi-modal transport, and in this manner serving as integral nodes in transportation networks. The operational context of an IHF is complex and dynamic. On one side of operations of an IHF, units arriving from customer locales may be in-gated (IG) into the IHF to be processed and then loaded onto trains for delivery to respective destinations. Upon arrival at the respective destinations, units are promptly unloaded and prepared for the final leg of their journey to the customer. On the other side of IHF operations, inbound (IB) units (e.g., units arriving at the IHF via trains carrying the units) are processed for customer delivery at the IHF. This high-volume processing of units, and the specific nature of the IB and IG processes underscores the critical role of IHF resources in handling the influx of IG units received from customers and IB units arriving via trains.

Although critical, these operations suffer inefficiencies due primarily to the current approach for managing IHF resources, which often operates to use resources as needed, without consideration as to the interplay between the various operations of the IHF. For example, in IHF operations, the competition for parking space allocation between IG and IB units often creates a logistical challenge. IG units, representing the incoming flux of units from customers into the IHF, may require processing for either storage or prompt preparation for onward transit onto an outbound train. In the meantime, while these IG units wait to be loaded onto an outbound train, these units are stored in parking lots of the IHF. Concurrently, IB units, representing the incoming flux of units via inbound trains into the IHF for subsequent pickup by a customer, may require efficient integration into the facility's workflow, ensuring that these units are sorted and dispatched to customers without undue delay. In the meantime, while these IB units wait to be picked up by a customer, these units are stored in parking lots of the IHF.

Upon the entry of units (e.g., containers) into the IHF facility, the assignment of each unit to a parking lot within the IHF is a critical step that is traditionally managed by a system that prioritizes immediate availability over strategic placement. Typically, the system allocates the arriving unit (e.g., a unit arriving in an inbound train or being dropped off by a customer) to a parking lot based on a simple criterion of the availability of open parking spots in the assigned parking lot, without consideration of more nuanced factors. In certain more sophisticated systems, parking assignments might take into account additional factors, such as grouping units from the same customer or units arriving on the same train within proximate areas. Nonetheless, even with these considerations, the prevailing methods often lead to logistical inefficiencies.

For example, units destined for the same location, scheduled for loading onto the same outbound train, or earmarked for pickup by the same customer can end up scattered across the IHF, sometimes not even within the same parking area or parking lot. This often-random scattering can result in units being positioned at far ends of the IHF or randomly distributed in less-than-ideal locations, necessitating that hostlers navigate longer distances and expend more time to consolidate these units for loading onto a train or for pickup by a customer. Such scenarios exacerbate the complexity of loading operations, with each unit's preparation and integration into the operational flow of the IHF consuming excessive time and resources, and impacting the overall efficiency and throughput of the IHF.

### SUMMARY

The present disclosure achieves technical advantages as systems, methods, and computer-readable storage media for intelligently diffusing unit storage across parking lot resources to maximize unit throughput in a hub based on a dual-stream resource optimization (DSRO). In embodiments, a unit diffusion manager may intelligently diffuse or spread units across the parking spots of a parking lot resource to which the units may be assigned based on unit characteristics to maximize unit throughput within the hub. The unit characteristics of a unit may include a unit-train assignment identifying the outbound train to which the unit may be assigned, a train-track assignment of the outbound train identifying the production track to which the outbound train is assigned for loading the units onto the outbound train, an identification of the customer to which the unit belongs, and/or other characteristics that may be relevant to the movement of the unit within the hub.

In embodiments, units arriving at a hub may be allocated a respective parking lot resource (e.g., a particular parking lot or a parking lot category) based on the expected dwell time of the units within the hub. In this case, the units may be expected to be stored within the allocated parking lot resource. In embodiments, the parking lot allocation may be performed by a parking lot optimization system based on an optimized operating schedule generated based on a DSRO, which may include parking lot allocation recommendations for units arriving during the planning horizon of the optimized operating schedule based on the expected dwell time of the units. In this manner, as a unit with an expected dwell time arrives at the hub at a time increment of the planning horizon, a parking lot category may be allocated to the unit based on the expected dwell time of the unit based on the optimized operating schedule. In this case, the unit may be expected to be stored within a parking lot having the allocated parking lot category.

The present disclosure provides further optimization of the parking lot allocations by providing functionality to diffuse the units assigned to the parking lot category across the parking spots of the parking lots having the parking lot category based on the unit characteristics of the units to maximize the unit throughput within the hub. For example, in embodiments, the unit characteristics of the units allocated to the parking lot resource may be fed into the unit diffusion manager, which may apply a model (e.g., based on a DSRO), and the unit diffusion manager may, based on the model, spread or diffuse the units assigned to the parking lot category across the parking spots of the parking lots having the parking lot category so as to minimize the time it may take to move the units from their respectively assigned parking spot to their respectively assigned outbound train (in the case of units flowing through the IG operational flow) or to their respectively associated customer (in the case of units flowing through the IB operational flow). For example, a set of units assigned to a first parking lot category may have unit characteristics indicating that the units in the set of units are assigned to the same outbound train. The unit characteristics may also indicate that the outbound train is to be processed (e.g., loaded with the units) in a first production track. In this case, the set of units may be diffused or spread across the parking lots having the first parking lot category such as to minimize the time it may take to move or transport the units from their respectively assigned parking spot to outbound train in the first production track.

The advantageous result of the intelligent unit diffusion functionality disclosed herein is that, by minimizing the transport time of the units in the set of units, the loading of the outbound train may be performed faster than without the diffusion, which leads to a higher number of units that may be turned over the planning horizon of the optimized operating schedule, maximizing the unit throughput within the hub over the planning horizon of the optimized operating schedule.

As such, it is clear that the present disclosure provides for a system integrated into a practical application with meaningful limitations as a system configured with a novel approach for intelligently diffusing unit storage across parking lot resources to maximize unit throughput in a hub based on a DSRO. A system implemented in accordance with embodiments of the present disclosure may provide improved functionality that may operate to obtain an optimized operating schedule including a consolidated time-space network and a deconsolidated time-space network over a planning horizon. In embodiments, the optimized operating schedule includes one or more parking lot allocation recommendations for allocating parking lot resources to units arriving at each time increment of the planning horizon. In embodiments, the improved functionality of the system implemented in accordance with embodiments of the present disclosure may further operate to optimize one or more parking lot allocation recommendations allocating a parking lot resource for one or more units determined to arrive at one or more time increments of the planning horizon by intelligently diffusing the one or more units to spread the one or more units across parking spots of the parking lot resource based on unit characteristics of the one or more units to minimize a transport time for moving the one or more units from respectively assigned parking spots to respectively assigned outbound transport, and to automatically send, during execution of the optimized operating schedule, a control signal to a controller to cause movement of the one or more units for placement of the one or more units into the respectively assigned parking spots based on the intelligently diffusing.

Thus, it will be appreciated that the technological solutions provided herein, and missing from conventional systems, are more than a mere application of a manual process to a computerized environment, but rather include functionality to implement a technical process to replace or supplement current manual solutions or non-existing solutions for optimizing resources in hubs. In doing so, the present disclosure goes well beyond a mere application the manual process to a computer. Accordingly, the claims herein necessarily provide a technological solution that overcomes a technological problem.

In various embodiments, a system may comprise one or more processors interconnected with a memory module, capable of executing machine-readable instructions. These instructions include, but are not limited to, instruction configured to implement the steps outlined in any flow diagram, system diagram, block diagram, and/or process diagram disclosed herein, as well as steps corresponding to a computer program process for implementing any functionality detailed herein, whether or not described with reference to a diagram. However, in typical implementations, implementing features of embodiments of the present disclosure in a computing system may require executing additional program instructions, which may slow down the computing system's performance. To address this problem, the present disclosure includes features that integrate parallel-processing functionality to enhance the solution described herein.

In embodiments, the parallel-processing functionality of systems of embodiments may include executing the machine-readable instructions implementing features of embodiments of the present disclosure by initiating or spawning multiple concurrent computer processes. Each computer process may be configured to execute, process or otherwise handle a designated subset or portion of the machine-readable instructions specific to the disclosure's functionalities. This division of tasks enables parallel processing, multi-processing, and/or multi-threading, allowing multiple operations to be conducted or executed concurrently rather than sequentially. By integrating this parallel-processing functionality into the solution described in the present disclosure, a system markedly increases the overall speed of executing the additional instructions required by the features described herein. This not only mitigates any potential slowdown but also enhances performance beyond traditional systems. Leveraging parallel or concurrent processing substantially reduces the time required to complete sets or subsets of program steps when compared to execution without such processing. This efficiency gain accelerates processing speed and optimizes the use of processor resources, leading to improved performance of the computing system. This enhancement in computational efficiency constitutes a significant technological improvement, as it enhances the functional capabilities of the processors and the system as a whole, representing a practical and tangible technological advancement. The integration of parallel-processing functionality into the features of the present disclosure results in an improvement in the functioning of the one or more processors and/or the computing system, and thus, represents a practical application.

In embodiments, the present disclosure includes techniques for training models (e.g., machine-learning models, artificial intelligence models, algorithmic constructs, etc.) for performing or executing a designated task or a series of tasks (e.g., one or more features of steps or tasks of processes, systems, and/or methods disclosed in the present disclosure). The disclosed techniques provide a systematic approach for the training of such models to enhance performance, accuracy, and efficiency in their respective applications. In embodiments, the techniques for training the models may include collecting a set of data from a database, conditioning the set of data to generate a set of conditioned data, and/or generating a set of training data including the collected set of data and/or the conditioned set of data. In embodiments, that model may undergo a training phase wherein the model may be exposed to the set of training data, such as through an iterative processes of learning in which the model adjusts and optimizes its parameters and algorithms to improve its performance on the designated task or series of tasks. This training phase may configure the model to develop the capability to perform its intended function with a high degree of accuracy and efficiency. In embodiments, the conditioning of the set of data may include modification, transformation, and/or the application of targeted algorithms to prepare the data for training. The conditioning step may be configured to ensure that the set of data is in an optimal state for training the model, resulting in an enhancement of the effectiveness of the model's learning process. These features and techniques not only qualify as patent-eligible features but also introduce substantial improvements to the field of computational modeling. These features are not merely theoretical but represent an integration of a concepts into a practical application that significantly enhance the functionality, reliability, and efficiency of the models developed through these processes.

In embodiments, the present disclosure includes techniques for generating a notification of an event that includes generating an alert that includes information specifying the location of a source of data associated with the event, formatting the alert into data structured according to an information format, and/or transmitting the formatted alert over a network to a device associated with a receiver based upon a destination address and a transmission schedule. In embodiments, receiving the alert enables a connection from the device associated with the receiver to the data source over the network when the device is connected to the source to retrieve the data associated with the event and causes a viewer application (e.g., a graphical user interface (GUI)) to be activated to display the data associated with the event. These features represent patent eligible features, as these features amount to significantly more than an abstract idea. These features, when considered as an ordered combination, amount to significantly more than simply organizing and comparing data. The features address the Internet-centric challenge of alerting a receiver with time sensitive information. This is addressed by transmitting the alert over a network to activate the viewer application, which enables the connection of the device of the receiver to the source over the network to retrieve the data associated with the event. These are meaningful limitations that add more than generally linking the use of an abstract idea (e.g., the general concept of organizing and comparing data) to the Internet, because they solve an Internet-centric problem with a solution that is necessarily rooted in computer technology. These features, when taken as an ordered combination, provide unconventional steps that confine the abstract idea to a particular useful application. Therefore, these features represent patent eligible subject matter.

In embodiments, one or more operations and/or functionality of components described herein can be distributed across a plurality of computing systems (e.g., personal computers (PCs), user devices, servers, processors, etc.), such as by implementing the operations over a plurality of computing systems. This distribution can be configured to facilitate the optimal load balancing of traffic (e.g., requests, responses, notifications, etc.), which can encompass a wide spectrum of network traffic or data transactions. By leveraging a distributed operational framework, a system implemented in accordance with embodiments of the present disclosure can effectively manage and mitigate potential bottlenecks, ensuring equitable processing distribution and preventing any single device from shouldering an excessive burden. This load balancing approach significantly enhances the overall responsiveness and efficiency of the network, markedly reducing the risk of system overload and ensuring continuous operational uptime. The technical advantages of this distributed load balancing can extend beyond mere efficiency improvements. It introduces a higher degree of fault tolerance within the network, where the failure of a single component does not precipitate a systemic collapse, markedly enhancing system reliability. Additionally, this distributed configuration promotes a dynamic scalability feature, enabling the system to adapt to varying levels of demand without necessitating substantial infrastructural modifications. The integration of advanced algorithmic strategies for traffic distribution and resource allocation can further refine the load balancing process, ensuring that computational resources are utilized with optimal efficiency and that data flow is maintained at an optimal pace, regardless of the volume or complexity of the requests being processed. Moreover, the practical application of these disclosed features represents a significant technical improvement over traditional centralized systems. Through the integration of the disclosed technology into existing networks, entities can achieve a superior level of service quality, with minimized latency, increased throughput, and enhanced data integrity. The distributed approach of embodiments can not only bolster the operational capacity of computing networks but can also offer a robust framework for the development of future technologies, underscoring its value as a foundational advancement in the field of network computing.

To aid in the load balancing, the computing system of embodiments of the present disclosure can spawn multiple processes and threads to process data traffic concurrently. The speed and efficiency of the computing system can be greatly improved by instantiating more than one process or thread to implement the claimed functionality. However, one skilled in the art of programming will appreciate that use of a single process or thread can also be utilized and is within the scope of the present disclosure.

It is an object of the disclosure to provide a method of intelligently diffusing unit storage across parking lot resources of a hub. It is a further object of the disclosure to provide a system for intelligently diffusing unit storage across parking lot resources of a hub, and a computer-based tool for intelligently diffusing unit storage across parking lot resources of a hub. These and other objects are provided by the present disclosure, including at least the following embodiments.

In one particular embodiment, a method of intelligently diffusing unit storage across parking lot resources of a hub is provided. The method includes obtaining an optimized operating schedule including a consolidated time-space network and a deconsolidated time-space network over a planning horizon. In embodiments, the optimized operating schedule includes one or more parking lot allocation recommendations for allocating parking lot resources to units arriving at each time increment of the planning horizon. The method also includes optimizing one or more parking lot allocation recommendations allocating a parking lot resource for one or more units determined to arrive at one or more time increments of the planning horizon by intelligently diffusing the one or more units to spread the one or more units across parking spots of the parking lot resource based on unit characteristics of the one or more units to minimize a transport time for moving the one or more units from respectively assigned parking spots to respectively assigned outbound transport, and automatically sending, during execution of the optimized operating schedule, a control signal to a controller to cause movement of the one or more units for placement of the one or more units into the respectively assigned parking spots based on the intelligently diffusing.

In another embodiment, a system for intelligently diffusing unit storage across parking lot resources of a hub is provided. The system comprises at least one processor and a memory operably coupled to the at least one processor and storing processor-readable code that, when executed by the at least one processor, is configured to perform operations. The operations include obtaining an optimized operating schedule including a consolidated time-space network and a deconsolidated time-space network over a planning horizon. In embodiments, the optimized operating schedule includes one or more parking lot allocation recommendations for allocating parking lot resources to units arriving at each time increment of the planning horizon. The operations also include optimizing one or more parking lot allocation recommendations allocating a parking lot resource for one or more units determined to arrive at one or more time increments of the planning horizon by intelligently diffusing the one or more units to spread the one or more units across parking spots of the parking lot resource based on unit characteristics of the one or more units to minimize a transport time for moving the one or more units from respectively assigned parking spots to respectively assigned outbound transport, and automatically sending, during execution of the optimized operating schedule, a control signal to a controller to cause movement of the one or more units for placement of the one or more units into the respectively assigned parking spots based on the intelligently diffusing.

In yet another embodiment, a computer-based tool for intelligently diffusing unit storage across parking lot resources of a hub is provided. The computer-based tool including non-transitory computer readable media having stored thereon computer code which, when executed by a processor, causes a computing device to perform operations. The operations include obtaining an optimized operating schedule including a consolidated time-space network and a deconsolidated time-space network over a planning horizon. In embodiments, the optimized operating schedule includes one or more parking lot allocation recommendations for allocating parking lot resources to units arriving at each time increment of the planning horizon. The operations also include optimizing one or more parking lot allocation recommendations allocating a parking lot resource for one or more units determined to arrive at one or more time increments of the planning horizon by intelligently diffusing the one or more units to spread the one or more units across parking spots of the parking lot resource based on unit characteristics of the one or more units to minimize a transport time for moving the one or more units from respectively assigned parking spots to respectively assigned outbound transport, and automatically sending, during execution of the optimized operating schedule, a control signal to a controller to cause movement of the one or more units for placement of the one or more units into the respectively assigned parking spots based on the intelligently diffusing.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following descriptions taken in conjunction with the accompanying drawings, in which:

FIG. 1 is a block diagram of an exemplary system configured with capabilities and functionality for intelligently diffusing unit storage across parking lot resources of a hub based on a dual-stream resource optimization (DSRO) in accordance with embodiments of the present disclosure.

FIG. 2 is a block diagram illustrating an example of a DSRO system configured with capabilities and functionality for intelligently diffusing unit storage across parking lot resources to maximize unit throughput in a hub based on a DSRO in accordance with embodiments of the present disclosure.

FIG. 3 is a block diagram of exemplary operations of a unit diffusion manager configured with functionality for intelligently diffusing unit storage across parking lot resources to maximize unit throughput in a hub based on a DSRO in accordance with embodiments of the present disclosure.

FIG. 4A shows an example of operations for assigning parking spots to units within a hub without intelligent unit diffusion.

FIG. 4B shows an example of operations for assigning parking spots to units within a hub using intelligent unit diffusion in accordance with embodiments of the present disclosure.

FIG. 5 is a flowchart illustrating operations for intelligently diffusing unit storage across parking lot resources of a hub based on a DSRO in accordance with embodiments of the present disclosure.

It should be understood that the drawings are not necessarily to scale and that the disclosed embodiments are sometimes illustrated diagrammatically and in partial views. In certain instances, details which are not necessary for an understanding of the disclosed methods and apparatuses or which render other details difficult to perceive may have been omitted. It should be understood, of course, that this disclosure is not limited to the particular embodiments illustrated herein.

### DETAILED DESCRIPTION

The disclosure presented in the following written description and the various features and advantageous details thereof, are explained more fully with reference to the non-limiting examples included in the accompanying drawings and as detailed in the description. Descriptions of well-known components have been omitted to not unnecessarily obscure the principal features described herein. The examples used in the following description are intended to facilitate an understanding of the ways in which the disclosure can be implemented and practiced. A person of ordinary skill in the art would read this disclosure to mean that any suitable combination of the functionality or exemplary embodiments below could be combined to achieve the subject matter claimed. The disclosure includes either a representative number of species falling within the scope of the genus or structural features common to the members of the genus so that one of ordinary skill in the art can recognize the members of the genus. Accordingly, these examples should not be construed as limiting the scope of the claims.

A person of ordinary skill in the art would understand that any system claims presented herein encompass all of the elements and limitations disclosed therein, and as such, require that each system claim be viewed as a whole. Any reasonably foreseeable items functionally related to the claims are also relevant. The Examiner, after having obtained a thorough understanding of the disclosure and claims of the present application has searched the prior art as disclosed in patents and other published documents, i.e., nonpatent literature. Therefore, the issuance of this patent is evidence that: the elements and limitations presented in the claims are enabled by the specification and drawings, the issued claims are directed toward patent-eligible subject matter, and the prior art fails to disclose or teach the claims as a whole, such that the issued claims of this patent are patentable under the applicable laws and rules of this country.

Various embodiments of the present disclosure are directed to systems and techniques that provide functionality for intelligently diffusing unit storage across parking lot resources to maximize unit throughput in a hub based on a dual-stream resource optimization (DSRO). In embodiments, the functionality for intelligently diffusing unit storage across parking lot resources of a hub may include functionality (e.g., of a unit diffusion manager) to intelligently diffuse or spread units across the parking spots of a parking lot resource to which the units may be assigned based on unit characteristics to maximize unit throughput within the hub. The unit characteristics of a unit may include a unit-train assignment identifying the outbound train to which the unit may be assigned, a train-track assignment of the outbound train identifying the production track to which the outbound train is assigned for loading the units onto the outbound train, an identification of the customer to which the unit belongs, and/or other characteristics that may be relevant to the movement of the unit within the hub.

For example, in embodiments, the unit characteristics of units allocated to a parking lot resource may be fed into the unit diffusion manager, which may spread or diffuse the units assigned to the parking lot resource across the parking spots of the parking lot resource so as to minimize the time it may take to move the units from their respectively assigned parking spot to their respectively assigned outbound train (in the case of units flowing through the IG operational flow) or to their respectively associated customer (in the case of units flowing through the IB operational flow). For example, a set of units assigned to a first parking lot category may have unit characteristics indicating that the units in the set of units are assigned to the same outbound train. The unit characteristics may also indicate that the outbound train is to be processed (e.g., loaded with the units) in a first production track. In this case, the set of units may be diffused or spread across the parking lots having the first parking lot category such as to minimize the time it may take to move or transport the units from their respectively assigned parking spot to outbound train in the first production track.

It is noted that the description that follows focuses on operations of a hub (e.g., an intermodal hub facility (IHF), a train yard, etc.) in which goods or units received from customers are placed on parking spots associated with the hub for eventual loading onto outbound trains to be transported to their respective destinations, and/or received from inbound trains carrying the units or goods that are unloaded and placed onto parking spots associated with the hub for eventual pickup by customers. However, the techniques described herein may be applicable in any application in which resources may be used in different operations, and where the intelligent utilization of the resources may impact the throughput of the system.

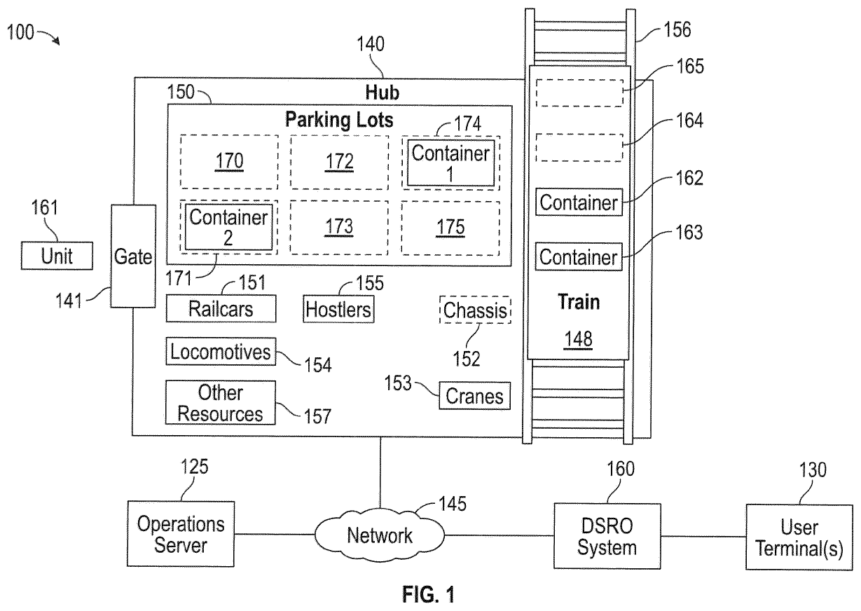

FIG. 1 is a block diagram of an exemplary system 100 configured with capabilities and functionality for intelligently diffusing unit storage across parking lot resources of a hub based on a DSRO in accordance with embodiments of the present disclosure. As shown in FIG. 1, system 100 may include user terminal 130, hub 140, network 145, operations server 125, and DSRO system 160. These components, and their individual components, may cooperatively operate to provide functionality in accordance with the discussion herein.

It is noted that the functional blocks, and components thereof, of system 100 of embodiments of the present disclosure may be implemented using processors, electronics devices, hardware devices, electronics components, logical circuits, memories, software codes, firmware codes, etc., or any combination thereof. For example, one or more functional blocks, or some portion thereof, may be implemented as discrete gate or transistor logic, discrete hardware components, or combinations thereof configured to provide logic for performing the functions described herein. Additionally, or alternatively, when implemented in software, one or more of the functional blocks, or some portion thereof, may comprise code segments operable upon a processor to provide logic for performing the functions described herein.

It is also noted that various components of system 100 are illustrated as single and separate components. However, it will be appreciated that each of the various illustrated components may be implemented as a single component (e.g., a single application, server module, etc.), may be functional components of a single component, or the functionality of these various components may be distributed over multiple devices/components. In such embodiments, the functionality of each respective component may be aggregated from the functionality of multiple modules residing in a single, or in multiple devices.

It is further noted that functionalities described with reference to each of the different functional blocks of system 100 described herein is provided for purposes of illustration, rather than by way of limitation and that functionalities described as being provided by different functional blocks may be combined into a single component or may be provided via computing resources disposed in a cloud-based environment accessible over a network, such as one of network 145.

User terminal 130 may include a mobile device, a smartphone, a tablet computing device, a personal computing device, a laptop computing device, a desktop computing device, a computer system of a vehicle, a personal digital assistant (PDA), a smart watch, another type of wired and/or wireless computing device, or any part thereof. In embodiments, user terminal 130 may provide a user interface that may be configured to provide an interface (e.g., a graphical user interface (GUI)) structured to facilitate an operator interacting with system 100, e.g., via network 145, to execute and leverage the features provided by server 110. In embodiments, the operator may be enabled, e.g., through the functionality of user terminal 130, to provide functionality for managing operations of hub 140 in accordance with embodiments of the present disclosure. For example, an operator may provide information related to train schedules, information related to units arriving at hub 140, information related to configuration of the parking lots within hub 140, information related to production track configurations, to request parking spot assignments, etc. In an additional or alternative example, the operator may receive information related to parking spot assignments for units, etc. In embodiments, user terminal 130 may be configured to communicate with other components of system 100.

In embodiments, network 145 may facilitate communications between the various components of system 100 (e.g., hub 140, DSRO system 160, and/or user terminal 130). Network 145 may include a wired network, a wireless communication network, a cellular network, a cable transmission system, a Local Area Network (LAN), a Wireless LAN (WLAN), a Metropolitan Area Network (MAN), a Wide Area Network (WAN), the Internet, the Public Switched Telephone Network (PSTN), etc.

Hub 140 may represent a hub (e.g., an IHF, a train station, etc.) in which units are processed as part of the transportation of the units. In embodiments, a unit may include containers, trailers, etc., carrying goods. For example, a unit may include a chassis carrying a container, and/or may include a container. In embodiments, units may be in-gated (IG) into hub 140 (e.g., by a customer dropping the unit into hub 140). The unit, including the chassis and the container (e.g., the chassis carrying the container), may be temporarily stored in a parking space of parking lots 150, while the container awaits being assigned to an outbound train. Once assigned to an outbound train, and once the outbound train is assigned to a production track (e.g., production tracks 156), the outbound train is placed on the production track and the container is moved from the parking spot in which the container is currently stored to the production track, where the container is removed from the chassis and the container is loaded onto the outbound train for transportation to the destination of the container. On the other side of operations, a container carrying goods may arrive at the hub via an inbound (IB) train (e.g., the IB train may represent an outbound train from another hub from which the container may have been loaded), may be unloaded from the IB train and may be temporarily stored in a parking spot of parking lots 150 for eventual pickup by a customer.

Hub 140 may be described functionally by describing the operations of hub 140 as comprising two distinct flows or streams. Units (e.g., containers being carried in chassis) flowing through a first flow (e.g., an IG flow) may be received through gate 141 from various customers for eventual loading onto an appropriate outbound train. For example, customers may drop off individual units (e.g., unit 161 including a container being carried in a chassis) at hub 140. The containers arriving through the IG flow may be destined for different destinations, and may be dropped off at hub 140 at various times of the day or night. As part of the IG flow, the containers arriving at hub 140, along with the chassis in which these containers arrive, may be assigned or allocated to parking spots in one or more of parking lots 150, while these containers wait to be assigned to and loaded onto an outbound train bound to the respective destination of the containers. Once an outbound train is ready to be loaded, the outbound train (e.g., train 148) may be assigned to and placed on a production track (e.g., production track 156). At this point, the containers assigned to the outbound train may be moved from their current parking spot to the production track to be loaded onto the outbound train to be taken to their respective destination.

Units flowing through a second flow (e.g., an IB flow) may arrive at hub 140 via an IB train (e.g., train 148 may arrive at hub 140), carrying containers, such as containers 162, 163, and/or other containers, which may eventually be unloaded from the inbound train to be placed onto chassis, assigned to and parked in parking spots of parking lot 150 to be made available for delivery to (e.g., for pickup by) customers.

For example, unit 141, including a container being carried in a chassis, may be currently being dropped off into hub 140 by a customer as part of the IG flow of hub 140, and may be destined to a first destination. In this case, as part of the IG flow, unit 141 may be in-gated into hub 140 and may be assigned to a parking spot (e.g., parking spot 175) in one of parking lots 150. In this example, container 1 may have been introduced into the IG flow of hub 140 by a customer (e.g., the same customer or a different customer) previously dropping off container 1 at hub 140 to be transported to some destination (e.g., the first destination or a different destination), and may have previously been assigned to parking spot 174 of parking lots 150, where container 1 may currently be waiting to be assigned and/or loaded onto an outbound train to be transported to the destination of container 1.

As part of the IG flow, the container in unit 141 and container 1 may be assigned to an outbound train. For example, in this particular example, train 148 may represent an outbound train that is schedule to depart hub 140 to the same destination as the container in unit 141 and container 1. In this example, the container in unit 141 and container 1 may be assigned to train 148. Train 148 may be placed on one of one or more production track 156 to be loaded. In this case, as part of the IG flow, train 148 is loaded (e.g., using one or more cranes 153) with containers, including the container in unit 141 and container 1. Once loaded, train 148 may depart to its destination as part of the IG flow.

With respect to the IB flow, train 148 may arrive at hub 140 carrying several containers, including containers 2, 162, and 163. It is noted that, as part of the dual stream operations of hub 140, some resources are shared and, in this example, train 148 may arrive at hub 140 as part of the IB flow before being loaded with containers as part of the IG flow as described above. Train 148 may be placed on one of one or more production tracks 156 to be unloaded a part of the IB flow. As part of the unloading operations, the containers being carried by train 148 and destined for hub 140, may be removed from train 148 (e.g., using one or more cranes 153) and each placed or mounted on a chassis. Once on the chassis, the containers are transported (e.g., using one or more hostlers 155) to an assigned parking spot of parking lots 150 to wait to be picked up by respective customers at which point the containers and the chassis on which the containers are mounted may exit or leave hub 140. For example, container 2 may be assigned to and parked on parking spot 172.

In embodiments, processing the units through the IG flow and the IB flow may involve the use of a wide variety of resources to consolidate the units from customers into outbound trains and/or to deconsolidate inbound trains into units for delivery to customers. These resources may include hub personnel (hostler drivers, crane operators, etc.), parking spaces, chassis, hostlers, cranes, tracks, railcars, locomotives, etc. These resources may be used to facilitate holding and/or moving the units through the operations of the hub.

For example, parking lots 150 may be used to park or store units while the units are waiting to be assigned to and loaded onto outbound trains or waiting to be picked up by customers. Parking lots 150 of hub 140 may include a plurality of parking lots, each of which may include a plurality of parking spots. In the example illustrated in FIG. 1, parking lots may include parking spots 170-175. In embodiments, parking lots 150 may represent physical parking lots that may be configured with a particular layout, orientation with respect to the production tracks of hub 140, and/or distance from the production tracks. In some embodiments, the various parking lots of parking lots 150 may have different categories, based on the accessibility to the production tracks 156 from the respective parking lots. For example, some parking lots may be categorized as beachfront parking lots, high-priority hub parking lots, low-priority hub parking lots, offsite parking lots, stacked parking lots, etc. During operations, units arriving at hub 140 may be allocated to parking lot categories, in which case a unit allocated to a particular parking lot category may be assigned to a parking spot in a parking lot having the allocated particular parking lot category.

The physical parking lots may be subdivided into individual parking spots or spaces. The layout of a physical parking lot may include one or more rows of parking spots laid out around the parking lot, as well as the transit lanes within the parking lot. In this case, some of the rows of the parking lot may enjoy a higher accessibility to some production tracks than other rows. Accessibility may be measured with respect to distance from the production track or even a faster route (e.g., with less obstacles, etc.). For example, a first row of a parking lot may be closer in distance from a first production track than a second row in the same parking lot. In another example, the second row of a parking lot may be closer in distance from a second production track than the first row in the same parking lot.

Chassis 152 (e.g., including, trucks, forklifts, and/or any structure configured to securely carry a container), and operators of chassis 152, may be used to securely carry units within hub 140. Hostlers 155 (e.g., including hostler operators, etc.) may be used to transport or move the units (e.g., containers on chassis) within hub 140, such as moving units to be loaded onto an outbound train or to move units unloaded from inbound trains. Cranes 153 may be used to load units onto departing trains (e.g., to unload units from chassis 152 and load the units onto the departing trains), and/or to unload units from arriving trains (e.g., e.g., to unload units from arriving trains and load the units onto chassis 152). Railcars 151 may be used to transport the units in the train. For example, a train may be composed of one or more railcars, and the units may be loaded onto the railcars for transportation. Arriving trains may include one or more railcars including units that may be processed through the second flow, and departing trains may include one or more railcars including units that may have been processed through the first flow. Railcars 151 may be assembled together to form a train. Locomotives 154 may include engines that may be used to power a train. Other resources 157 may include other resources not explicitly mentioned herein but configured to allow or facilitate units to be processed through the first flow and/or the second flow.

In embodiments, operations server 125 may be configured to provide functionality for facilitating operations of hub 140. In embodiments, operations server 125 may include data and information related to operations of hub 140, such as current inventory of all hub resources (e.g., chassis, hostlers, drivers, lift capacity, parking lot and parking spaces, IG capacity limits, railcar, locomotives, tracks, etc.). This hub resource information included in operations server 125 may change over time as resources are consumed, replaced, and/or replenished, and operations server 125 may have functionality to update the information. Operations server 125 may include data and information related to inbound and/or outbound train schedules (e.g., arriving times, departure times, destinations, origins, capacity, available spots, inventory list of units arriving in inbound trains, etc.). In particular, inbound train schedules may provide information related to inbound trains that are scheduled to arrive at the hub during the planning horizon an optimized operating schedule (as described herein), which may include scheduled arrival time, origin of the inbound train, capacity of the inbound train, a list of units loaded onto the inbound train, a list of units in the inbound train destined for the hub (e.g., to be dropped off at the hub), etc. With respect to outbound train schedules, the outbound train schedules may provide information related to outbound trains that are scheduled to depart from the hub during the planning horizon, including scheduled departure time, capacity of the outbound train, a list of units already scheduled to be loaded onto the outbound train, destination of the outbound train, etc. In embodiment, the information from operations server 125 may be used (e.g., by DSRO system 160) to develop, generate, and/or update an optimized operating schedule based on a DSRO for managing the resources of hub 140 over a planning horizon.

In embodiments, operations server 125 may provide functionality to manage the execution of the optimized operational schedule (e.g., an optimized operating schedule generated in accordance with embodiments of the present disclosure) over the planning horizon of the optimized operating schedule. The optimized operating schedule may represent recommendations made by DSRO system 160 of how units arriving at each time increment of the planning horizon are to be processed, and how resources of hub 140 are to be managed to maximize unit throughput through the hub over the planning horizon of the optimized operating schedule. Particular to the present disclosure, the optimized operating schedule may include recommendations associated with the allocation of parking lot categories to units arriving at the hub at each time increment of the planning horizon. In this manner, as a unit arrives at the hub 140 at a time increment, the unit may be allocated a parking lot category based on the parking lot assignment recommendations in the optimized operational schedule for the time increment. The recommendations may be based on the expected or known dwell time of the unit within hub 140. In embodiments, the parking lot allocation recommendations of the units may be further optimized or refined by applying the intelligent diffusion functionality of embodiments to intelligently spread or diffuse the units across parking spots of the parking lots (e.g., the parking lots having the allocated parking lot categories) to minimize the transport time of the units from their respective parking spot to their respectively assigned outbound train (in the case of IG units) and/or from their respective parking spot to their respectively associated customer transport (e.g., in the case of IB units being picked up by customers).

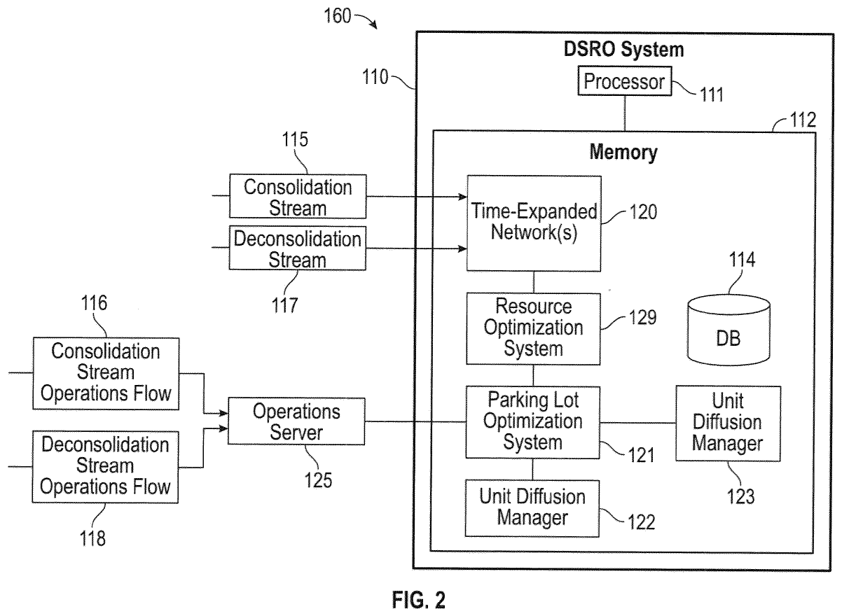

In embodiments, operations server 125 may manage execution of the optimized operational schedule by monitoring the consolidation stream operations flow (e.g., consolidation stream operations flow 116 of FIG. 2, which may represent the actual unit traffic flow through the IG flow during execution of the optimized operating schedule) and deconsolidation stream operations flow (e.g., deconsolidation stream operations flow 118 of FIG. 2, which may represent the actual unit traffic flow through the IB flow during execution of the optimized operating schedule) to ensure that the optimized operational schedule is being executed properly, and to update the optimized operating schedule based on the actual unit traffic, which may impact resource availability and/or consumption, especially when the actual unit traffic during execution of the optimized operational schedule differs from the predicted unit traffic used in the generation of the optimized operational schedule. In embodiments, operations server 125 may operate to provide functionality that may be leveraged during execution of the optimized operational schedule over a planning horizon to ensure that unit throughput through the hub is maximized over the planning horizon.

In embodiments, as noted above, operations server 125 may operate to provide functionality that may be leveraged during execution of the optimized operational schedule over a planning horizon to ensure that unit throughput through the hub is maximized over the planning horizon. This functionality of operations server 125 may include functionality to allocate parking lot categories to arriving units (e.g., arriving through the IG and/or IG flows) and to intelligently diffuse the units, based on unit characteristics, over parking spots of the parking lots having the allocated parking lot categories in accordance and/or based on the optimized operating schedule over the planning horizon. In embodiments, operations server 125 may include functionality to ensure that the optimized operating schedule is updated based on actual operations, such as based on actual resource consumption (e.g., based on actual units arriving, the type of units arriving such as short-dwell, medium dwell, long-dwell, actual inbound trains arrival times, actual outbound trains departure times, etc.).

DSRO system 160 may be configured to manage resources of hub 140 based on a DSRO to maximize unit throughput within hub 140 in accordance with embodiments of the present disclosure. For example, DSRO system 160 may be configured to generate an optimized operating schedule may represent recommendations by DSRO system 160 of how units arriving at each time increment of the planning horizon are to be processed, and/or how resources of hub 140 are to be managed to maximize unit throughput through the hub over the planning horizon of the optimized operating schedule. In particular, DSRO system 160 may be configured to provide the main functionality of system 100 to intelligently spread or diffuse units across parking spots of parking lot categories allocated to the units to minimize the transport time of the units from their respective parking spot to their respectively assigned outbound transport (e.g., respectively assigned outbound train (in the case of IG units) and/or respectively associated customer transport (e.g., in the case of IB units being picked up by customers)). For example, in embodiments, DSRO system 160 may implement the intelligent unit diffusion functionality by leveraging the functionality of a unit diffusion manager (e.g., unit diffusion manager 122 of FIG. 2).

FIG. 2 is a block diagram illustrating an example of DSRO system 160 configured with capabilities and functionality for intelligently diffusing unit storage across parking lot resources to maximize unit throughput in a hub based on a DSRO in accordance with embodiments of the present disclosure. As shown in FIG. 2, DSRO system 160 may be implemented in a server (e.g., server 110). In embodiments, functionality of server 110 to facilitate operations of DSRO system 160 may be provided by the cooperative operation of the various components of server 110, as will be described in more detail below.

It is noted that although FIG. 2 shows server 110 as a single server, it will be appreciated that server 110 (and the individual functional blocks of server 110) may be implemented as separate devices and/or may be distributed over multiple devices having their own processing resources, whose aggregate functionality may be configured to perform operations in accordance with the present disclosure. Furthermore, those of skill in the art would recognize that although FIG. 2 illustrates components of server 110 as single and separate blocks, each of the various components of server 110 may be a single component (e.g., a single application, server module, etc.), may be functional components of a same component, or the functionality may be distributed over multiple devices/components. In such embodiments, the functionality of each respective component may be aggregated from the functionality of multiple modules residing in a single, or in multiple devices. In addition, particular functionality described for a particular component of server 110 may actually be part of a different component of server 110, and as such, the description of the particular functionality described for the particular component of server 110 is for illustrative purposes and not limiting in any way.

As shown in FIG. 2, server 110 includes processor 111, memory 112, time-expanded network 120, parking lot optimization system 121, unit diffusion manager 122, resources optimization system 129, and database 114.

Processor 111 may comprise a processor, a microprocessor, a controller, a microcontroller, a plurality of microprocessors, an application-specific integrated circuit (ASIC), an application-specific standard product (ASSP), or any combination thereof, and may be configured to execute instructions to perform operations in accordance with the disclosure herein. In some embodiments, implementations of processor 111 may comprise code segments (e.g., software, firmware, and/or hardware logic) executable in hardware, such as a processor, to perform the tasks and functions described herein. In yet other embodiments, processor 111 may be implemented as a combination of hardware and software. Processor 111 may be communicatively coupled to memory 112.

Memory 112 may comprise one or more semiconductor memory devices, read only memory (ROM) devices, random access memory (RAM) devices, one or more hard disk drives (HDDs), flash memory devices, solid state drives (SSDs), erasable ROM (EROM), compact disk ROM (CD-ROM), optical disks, other devices configured to store data in a persistent or non-persistent state, network memory, cloud memory, local memory, or a combination of different memory devices. Memory 112 may comprise a processor readable medium configured to store one or more instruction sets (e.g., software, firmware, etc.) which, when executed by a processor (e.g., one or more processors of processor 111), perform tasks and functions as described herein.

Memory 112 may also be configured to facilitate storage operations. For example, memory 112 may comprise database 114 for storing various information related to operations of system 100. For example, database 114 may store configuration information related to operations of DSRO system 160. In embodiments, database 114 may store information related to various models used during operations of DSRO system 160, such as a DSRO model, a parking lot optimization model, a parking lot classification model, an ingate prediction model, an inbound prediction model, a unit diffusion model, etc. Database 114 is illustrated as integrated into memory 112, but in some embodiments, database 114 may be provided as a separate storage module or may be provided as a cloud-based storage module. Additionally, or alternatively, database 114 may be a single database, or may be a distributed database implemented over a plurality of database modules.

As mentioned above, operations of hub 140 may be represented as two distinct flows, an IG flow in which units arriving to hub 140 from customers are consolidated into outbound trains to be transported to their respective destinations, and an IB flow in which inbound trains arriving to hub 140 carrying units are deconsolidated into the units that are stored in parking lots while waiting to be picked up by respective customers. DSRO system 160 may be configured to represent the IG flow as consolidation stream 115 including a plurality of stages. Each stage of consolidation stream 115 may represent different operations or events that may be performed or occur to facilitate the IG flow of hub 140. DSRO system 160 may be configured to represent the IB flow as deconsolidation stream 117 including a plurality of stages. Each stage of deconsolidation stream 117 may represent different operations or events that may be performed or occur to facilitate the IB flow of hub 140.

In embodiments, the interaction between consolidation stream 115 and deconsolidation stream 117, with respect to the use of resources of hub 140, may be collaborative or competing. For example, parking spaces of parking lots 150 may be used to store units flowing through consolidation stream 115 while the units are waiting to be ramped onto an outbound train. However, parking spaces of parking lots 150 may also be used to store units processed through deconsolidation stream 117 (e.g., units unloaded from an inbound train), while these units are waiting to be picked up by a customer. In this manner, consolidation stream 115 and deconsolidation stream 117 may compete for the use of parking lots 150 within hub 140 during operations (e.g., during execution of an operating schedule).

In another example, the utilization of chassis resources within hub 140 between consolidation stream 115 and deconsolidation stream 117 may be collaborative. In this case, containers dropped off at hub 140 by customers are typically dropped off on a chassis. In this manner, when a container enters hub 140 through consolidation stream 115, an additional chassis is added to the chassis resource capacity of hub 140. As such, consolidation stream 115, and specifically the ramping stage of consolidation stream 115, operates to supply or increase chassis resources to the chassis resource capacity of hub 140. On the other hand, from deconsolidation stream 117's perspective, containers arriving at hub 140 may require a chassis upon which to be mounted before the containers may be unloaded from the inbound train during the deramping stage of deconsolidation stream 117. The chassis used to receive an unloaded container is used from the current chassis resource capacity of hub 140 and once a container is placed or mounted on a chassis, the chassis is no longer available to receive another container. Therefore, deconsolidation stream 117, and specifically the deramping stage of deconsolidation stream 117, operates to consume or decrease chassis resources from the chassis resource capacity of hub 140. In this manner, as consolidation stream 115 supplies chassis resources and deconsolidation stream 117 consumes chassis resources, consolidation stream 115 and deconsolidation stream 117 have a collaborative relationship in which one supplies resources and the other consumes the supplied resources.

In embodiments, DSRO system 160 may be configured to optimize the use of resources to maximize the throughput of the hub (e.g., the rate of units processed through the hub) by generating one or more time-space networks 120 to represent consolidation stream 115 and deconsolidation stream 117, and configuring the DSRO model to use one or more time-space networks 120, over a planning horizon, to optimize the use of the resources of the hub that support the unit flow within the planning horizon to maximize the throughput of units over the planning horizon. In embodiments, the DSRO model may generate, based on the one or more time-space networks 120, an optimized operating schedule that includes one or more of a determined unit flow through one or more of the stages of each time-space network (e.g., the consolidation and/or deconsolidation stream time-space networks) at each time increment of the planning horizon, an indication of a resource deficit or overage at one or more of the stages of each time-space network at each time increment of the planning horizon, and/or an indication or recommendation of a resource replenishment to be performed at one or more of the stages of each time-space network at each time increment of the planning horizon to ensure the optimized operating schedule is met. Particular to the present disclosure, the optimized operating schedule may include recommendations for allocating units of particular types (e.g., particular dwell time type) to parking lots categories through each of the consolidation stream 115 and/or deconsolidation stream 117 at each time increment of the planning horizon, based on predictions and/or expectations of the optimized operating schedule (e.g., predicted or expected dwell time of the units, predicted and/or expected unit traffic, resource consumption, resource availability, resource capacity, environmental factors, etc.). In embodiments, the parking lot allocation recommendations may be further refined or optimized by applying the intelligent diffusion unit diffusion to the recommendations to intelligently spread or diffuse the units across parking spots of the parking lot categories allocated to the units to minimize the transport time of the units from their respective parking spot to their respectively assigned outbound transport (e.g., respectively assigned outbound train (in the case of IG units) and/or respectively associated customer transport (e.g., in the case of IB units being picked up by customers)).

In embodiments, DSRO system 160 may be configured to apply the generated DSRO model to the time-expanded networks 120 to optimize the use of the resources (e.g., parking lot resources) by the consolidation and deconsolidation streams over the planning horizon to maximize throughput of the hub over the planning horizon. To that end, DSRO 160 may include a plurality of optimization systems. For example, resource optimization system 129 may be configured to generate, based on the DSRO model, an optimized operating schedule that may be implemented over a planning horizon to maximize throughput of units through the hub. In particular, resource optimization manager 129 may be configured to consider resource availability (e.g., resource inventory), resource replenishment cycles, resource cost, operational implications of inadequate supply of resources, for all the resources involved in the consolidation and deconsolidation streams to determine the optimized operating schedule that may maximize throughput through the hub over the planning horizon. Resource optimization manager 129 may be configured to additionally consider unit volumes (e.g., unit volumes expected to flow during the planning horizon through the consolidation stream and the deconsolidation streams, such as at each time increment of the planning horizon) and unit dwell times (e.g., expected dwell times of units flowing through the consolidation stream and the deconsolidation streams during the planning horizon) to determine the optimized operating schedule that may maximize throughput through the hub over the planning horizon

During operations (e.g., during execution of the operating schedule, when units arrive at the hub), operations server 125 may operate to manage execution of the optimized operational schedule by monitoring consolidation stream operations flow 116 (e.g., the actual traffic flow through the consolidation stream 115 during execution of the optimized operating schedule) and deconsolidation stream operations flow 118 (e.g., the actual traffic flow through the deconsolidation stream 117 during execution of the optimized operating schedule) to ensure that the optimized operational schedule is being executed properly, and to update the optimized operating schedule based on the actual unit traffic, which may impact resource availability and/or consumption, especially when the actual unit traffic during execution of the optimized operational schedule differs from the predicted unit traffic used in the generation of the optimized operational schedule.

In embodiments, the functionality of DSRO system 160 to optimize the utilization of parking lots 150 of hub 140 may include leveraging the functionality of parking lot optimization system 121 to define, refine, or otherwise determine parking lot allocation operations in an optimized manner, which may facilitate implementation of the optimized operating schedule.

For example, in embodiments, parking lot optimization system 121 may be configured to generate parking lot allocation recommendations for the optimized operating schedule such that, for each time increment of the planning horizon, parking lot categories are allocated to units expected to arrive during each of the time increment based on the expected dwell time of the arriving units and/or based on the parking lot categories. For example, for a first time increment within the planning horizon, an optimized operating schedule may expect a number of short-dwelling units and a number of long-dwelling units. In this example, parking lot optimization system 121 may further optimize the operating schedule by allocating, for the first time increment, a parking lot category (e.g., a high-priority parking lot) to the short-dwelling units and a parking lot category (e.g., a lower-priority parking lot) to the long-dwelling units, based on the parking lot capacity and/or expected available parking spaces. In this manner, parking lot optimization system 121 may be configured to maximize the throughput of the parking lot spaces of hub 140 by ensuring that short-dwelling units are assigned to parking spaces that are easily accessible, that medium-dwelling units to are assigned to parking spaces that are somewhat less accessible than the easily accessible parking spaces, and so on. In embodiments, parking lot optimization system 121 may consider the interaction between the consolidation stream time-space network and the deconsolidation stream time-space network, and the unit volume and dwell time composition of each stream while allocating the units to parking lots optimally.

In embodiments, parking lot optimization system 121 may cooperatively operate with parking lot categorization system 123, which may be configured to classify or categorize parking lots of parking lots 150 into different categories, depending, in some embodiments, on their proximity or accessibility to production tracks, their proximity or accessibility to hostler storage, their proximity or accessibility to the ingate (e.g., for customer pickup), etc. In this manner, the category of a parking lot, which may be based on the accessibility of the parking lot, may be useful when determining how accessible a unit stored in the parking lot is to be moved, which may impact the throughput of the parking lots. The parking lot categories may be used by the parking lot optimization system 121 to allocate parking lots to expected units at each time increment of the planning horizon of the optimized operating schedule.

In embodiments, unit diffusion manager 122 may be configured to further refine or optimize the parking lot allocation recommendations generated by parking lot optimization system 121 by applying an intelligent diffusion algorithm, process, or model to the parking lot allocation recommendations to intelligently spread or diffuse the units allocated to the parking lot categories across parking spots of the parking lot categories allocated to the units to minimize the transport time of the units from their respective parking spot to their respectively assigned outbound transport (e.g., respectively assigned outbound train (in the case of IG units) and/or respectively associated customer transport (e.g., in the case of IB units being picked up by customers)).

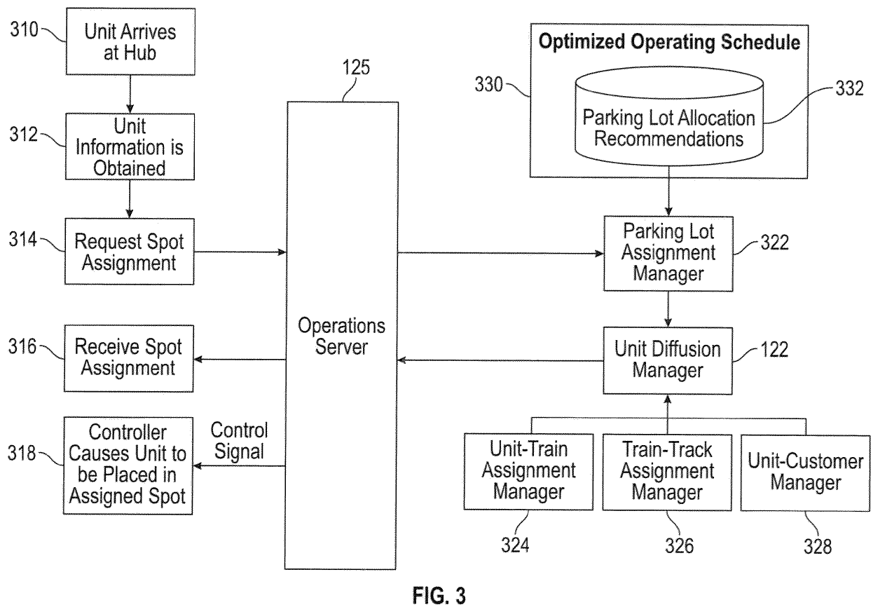

Operations and functionality of unit diffusion manager 122 will now be discussed with respect to FIG. 3. FIG. 3 is a block diagram of exemplary operations of a unit diffusion manager 122 configured with functionality for intelligently diffusing unit storage across parking lot resources to maximize unit throughput in a hub based on a DSRO in accordance with embodiments of the present disclosure. In embodiment, operations illustrated in the example shown in FIG. 3 may be performed by a system (e.g., system 100 of FIG. 1) according to embodiments herein.

In embodiments, operations server 125 may include functionality to manage and/or coordinate the execution of an optimized operating schedule (e.g., optimized operating schedule 330). As noted above, optimized operating schedule 330 may represent recommendations made by DSRO system 160 of how units arriving at each time increment of the planning horizon of optimized operating schedule 330 are to be processed, and how resources of hub 140 are to be managed to maximize unit throughput through the hub over the planning horizon of optimized operating schedule 330. In embodiments, optimized operating schedule 332 may include parking lot allocation recommendations 332, which may include recommendation associated with the allocation of parking lot categories to units arriving at the hub at each time increment of the planning horizon. In embodiments, parking lot allocation recommendations 332 may be generated by leveraging the functionality of a parking lot optimization system (e.g., parking lot optimization system 121 of FIG. 2) to allocate a parking lot category to each unit expected to arrive at each time increment of the planning horizon of optimized operating schedule 330. The parking lot optimization system may recommend an allocation of a parking lot category to a unit expected to arrive at a time increment of the planning horizon based on the dwell time of the unit (e.g., a short dwelling unit may be assigned to a higher-priority parking lot category than a longer dwelling unit). A higher-priority parking lot category may represent one or more parking lots from which one or more production tracks may be more accessible (e.g., closer or with less obstacles) than from parking lots with a lower-priority parking lot category. In this manner, the parking lot optimization system may facilitate maximizing the unit throughput within the parking lots by ensuring that units are allocated the optimum parking lot category to ensure that unit throughput is maximized. For example, shorter dwelling units may be allocated parking lots that are easily accessible to the production tracks, longer dwelling units may be allocated parking lots that are somewhat less accessible to the production tracks than the easily accessible parking lots, even longer dwelling units may be allocated parking lots that are even less accessible to the production tracks than the somewhat easily accessible parking lots, and so on, which ensures that more units may be moved (e.g., turned) to the production tracks during each time increment. In embodiments, the parking lot optimization system may consider the interaction between the consolidation stream time-space network and the deconsolidation stream time-space network, and the unit volume and dwell time composition of each stream, over the entire planning horizon, while allocating the units to parking lot categories optimally at each time increment. Systems and devices for optimizing utilization of parking lot resources of a hub based on a dual-stream resource optimization are disclosed in pending and co-owned U.S. Patent Application Docket No. BNSF-00223CIP1, entitled “SYSTEM AND METHOD FOR OPTIMIZING UTILIZATION OF PARKING LOT RESOURCES OF A HUB BASED ON A DUAL-STREAM RESOURCE OPTIMIZATION, the entirety of which is herein incorporated by reference for all purposes. In embodiments, unit diffusion manager 122 may be configured to further optimize the optimized operating schedule 330 by refining parking lot allocation recommendations 332 through the application of the intelligent unit diffusion functionality to intelligently spread or diffuse the assignment of the parking spots of the parking lots (e.g., the parking lots having the allocated parking lot categories) to the units based on the unit characteristics (e.g., unit-train assignment of the unit, train-track assignment of the unit's assigned outbound train, and/or the customer associated with the unit) in such a manner as to minimize the transport time of the units from their respective parking spot to their respective outbound transport, which may include a respectively assigned outbound train (in the case of IG units) and/or a respective customer transport (e.g., in the case of IB units being picked up by customers). In this manner, while parking lot allocation recommendations 332 may facilitate optimized parking lot category allocations to the units (e.g., based on the dwell time of the units), the intelligent unit diffusion functionality of unit diffusion manager 122 may facilitate optimized parking spot assignments to the units within the allocated parking lot categories.

During operations, as shown in FIG. 3, at block 310, a unit is received at the hub (e.g., hub 140 as illustrated in FIG. 1) at a time increment of the planning horizon of optimized operating schedule 330. The unit received at the hub at 310 may represent a unit (e.g., a container) arriving at the hub via in an inbound train through the IB flow or may represent a unit (e.g., a container) being dropped off at the hub by a customer through the IG flow. At block 312, information associated with the unit may be obtained. For example, in the case of the unit arriving in an inbound train, the system may collect or obtain unit information including the ID of the unit, the destination of the unit (e.g., the unit may be destined for hub 140), the customer to which the unit belongs, the contents of the unit, the weight of the unit, the size of the unit, etc. In the case of the unit being dropped off by the customer, the collected unit information may include the ID of the unit, the customer associated with the unit, the destination of the unit, the contents of the unit, the weight of the unit, the size of the unit, etc.

At block 314, a request for a parking spot assignment may be submitted to operations server 125. In embodiments, the parking spot assignment request may be submitted using a client application (e.g., an application used by an operator transporting the unit) or may be automatically submitted upon detection of the unit arrival (e.g., by one or more sensors, such as a camera or other sensors configured to detect a unit) or upon arrival of the inbound train carrying the unit. In embodiments, the parking spot assignment request may include the unit information collected at block 312.

In response to receiving the parking spot assignment, operations server 125 may cause parking lot assignment manager 322 to obtain a parking lot category allocation for the unit. In embodiments, the parking lot category allocation for the unit may be obtained based on the parking lot allocation recommendations 332 in optimized operating scheduled 330. For example, parking lot allocation recommendations 332 in optimized operating schedule 330 may include a recommendation of a parking lot category to allocate to a unit arriving at the time increment in which the unit arrived and having the dwell time of the unit. In this case, based on the recommendation in the optimized operating schedule 330, the recommended parking lot category may be allocated to the unit. Based on the parking lot category allocated to the unit, operations server 125 may assign the unit to a parking lot (or parking lots) having the allocated parking lot category. In this manner, the parking lot allocation recommendation in optimized operating schedule 330 may operate to assign the unit to the optimum parking lot(s) based on the unit's dwell time.

In embodiments, with the parking lot category allocated to the unit, unit diffusion manager 122 may operate to assign the unit to a parking spot based on the intelligent unit diffusion functionality of unit diffusion manager 122. As noted herein, the intelligent unit diffusion functionality of unit diffusion manager 122 may operate to intelligently spread units across the parking spots of a parking lot (e.g., the parking lot(s) having the allocated parking lot category) based unit characteristics (e.g., unit-train assignment, train-track assignment, customer associated with the unit, etc.) to ensure that the unit throughput over planning horizon withing the hub is maximized. Unit diffusion manager 122 accomplishes this by spreading the assignment of the units to minimize the transport time of the units from the respectively assigned parking spot to the production track in which the respectively assigned outbound train is to be loaded, which may lead to a higher number of units that may be turned over the planning horizon of optimized operating schedule 330. As such, unit diffusion manager 122 may assign the unit to a parking spot within a parking lot (or parking lots) having the allocated parking lot category, where the parking spot is determined to ensure that units arriving at the hub over the planning horizon of optimized operating schedule 330 and allocated to the same parking lot category are intelligently diffused across the parking spots of the allocated parking lot category.

In embodiments, intelligently diffusing units across the allocated parking lot category may include a systematic assignment of parking spots to the units based on the unit characteristics of the units. The unit characteristics may represent an array of factors that may define each unit's unique profile and operational requirements within the logistical framework of the hub. For example, in embodiments, the unit characteristics of a unit may include a unit-train assignment identifying the outbound train to which the unit may be assigned, a train-track assignment of the outbound train identifying the production track to which the outbound train is assigned for loading the units onto the outbound train, an identification of customers associated with the units, and/or other characteristics that may be relevant to the movement of the unit within the hub. The unit characteristics may represent crucial characteristics for orchestrating the optimized movement and management of the units within the hub's operational context (e.g., loading and/or unloaded the units to and/or from a train). In embodiments, unit diffusion manager 122, may be configured to consider the physical layout and configuration of the parking lot(s) when determining the diffusion pattern or layout of units across the allocated parking lot categories. This may include evaluating the spatial arrangement, access points, and any potential impediments that could influence the optimal placement of units with respect to the production tracks assigned to the outbound train.

It is noted that one of the objective underpinning the intelligent diffusion functionality of unit diffusion manager 122 is to minimize the distance and enhance the accessibility between the units' parking spots and the production tracks assigned to the for loading or unloading the outbound train respectively assigned to the units. By prioritizing routes with fewer obstacles and shorter travel distances, unit diffusion manager 122 significantly improves the loading and unloading operations. This optimization of logistical movements directly contributes to an increase in the throughput of units over the planning horizon of optimized operating schedule 330, improving the overall efficiency and productivity of the hub's operations.

One of the advantageous results, among others, of the intelligent diffusion is that units destined for a similar destination (or assigned to a same train) are positioned in an optimum arrangement with respect to the production track in which the outbound train scheduled to carry the units (e.g., are parked in parking spots optimally close to the production track assigned to the outbound train).

In embodiments, unit diffusion manager 122 may be configured with functionality to obtain unit-train assignments for individual units from unit-train assignment manager 324. A unit-train assignment may include an assignment of a unit to an outbound train that may carry the unit out of the hub and en route to the unit's destination. Unit-train assignment manager 324 may be configured to determine, for each unit arriving at the hub via the IG flow (e.g., for each unit dropped off at the hub by a customer), the outbound train to which the unit is assigned or a prediction of which train the units is likely to be assigned to. For example, unit-train assignment manager 324 may determine, and provide to unit diffusion manager 122, an outbound train assignment for the unit in the example shown in FIG. 3. In embodiments, unit diffusion manager 122 may use the unit-train assignment of the unit to determine the outbound train to which the unit is assigned. Unit diffusion manager 122 may determine other units (e.g., other units arriving at the hub over the planning horizon of optimized operating schedule 330) that may also be assigned to the same outbound train and may (e.g., further based on the train-track assignment of the outbound train) assign a parking spot to the unit (and to the other units also assigned to the same outbound train) within the allocated parking lot category configured to minimize the time it may take to move the units from their respectively assigned parking spot to the outbound train for loading, maximizing the unit throughput over the planning horizon of optimized operating schedule 330.

In embodiments, unit-train assignment manager 324 may determine the outbound train assignment for the unit based on an analysis of active train schedules. These active train schedules may include detailed information regarding the timings, dates, frequencies, destinations, etc. of the various trains arriving and departing the hub (e.g., over the planning horizon of optimized operating schedule 330). Leveraging this information, unit-train assignment manager 324 may determine the actual or probable outbound train to which a unit may be assigned, such as based on the unit's destination.

In embodiments, such as in situation in which active train schedules are either not accessible or not available (e.g., due to operational constraints or unforeseen circumstances), unit-train assignment manager 324 may be configured to implement an analytical approach based on historical data pertaining to train movements through the hub. By analyzing past train traffic patterns, frequencies, destinations, etc., unit-train assignment manager 324 may make educated predictions about potential outbound trains that are likely to depart from the hub for the unit's intended destination during the planning horizon of optimized operating schedule 330, and at which likely time/dates, etc. This functionality ensures that, even in the absence of real-time scheduling data, there remains a mechanism for determining a potential assignment of units to outbound trains, which may serve to maintain the operational continuity and efficiency of the system described herein.

In embodiments, unit diffusion manager 122 may obtain the train-track assignment from train-track assignment manager 326. A train-track assignment may include an assignment of an outbound train to a production track in which the outbound train for loading the units onto the outbound train. Train-track assignment manager 326 may be configured to determine the production track to which each outbound train is assigned or a prediction of which production track each outbound train is likely to be assigned to for loading of each respective outbound train. For example, train-track assignment manager 326 may determine, and provide to unit diffusion manager 122, a production track to which the outbound train assigned to which the unit is assigned to be loaded with the unit (and other units bound to a similar destination). In embodiments, unit diffusion manager 122 may use the train-track assignment of the outbound train to which the unit is assigned to determine the production track in which the outbound train is to be built, loaded, or consolidated. Unit diffusion manager 122 may assign a parking spot to the unit (and to the other units also assigned to the same outbound train) within the allocated parking lot category configured to minimize the time it may take to move the units from their respectively assigned parking spot to the production track in which the outbound train is to be loaded, maximizing the unit throughput over the planning horizon of optimized operating schedule 330.

In embodiments, train-track assignment manager 326 may determine the production track to which an outbound train is assigned to be loaded (e.g., consolidated or built) or unloaded (e.g., deconsolidated or taken apart) based on an analysis of active train schedules. These active train schedules may include detailed information regarding the various trains scheduled to arrive and/or depart from the hub, and may include indications of the production tracks to which the trains may be assigned. Leveraging this information, train-track assignment manager 326 may determine the actual or probable production track to which an outbound train may be assigned to be loaded or unloaded.

In embodiments, such as in situation in which active train schedules are either not accessible or not available (e.g., due to operational constraints or unforeseen circumstances), train-track assignment manager 326 may be configured to determine the production track to which an outbound train may be assigned to be loaded or unloaded based on analysis of historical data pertaining to train movements through the hub. By analyzing past train traffic patterns, frequencies, destinations, etc., train-track assignment manager 326 may make educated predictions about potential production tracks to which various trains arriving to or departing from the hub over the planning horizon of optimized operating schedule 330 may be likely to be assigned for consolidation or deconsolidation. This functionality ensures that, even in the absence of real-time scheduling data, there remains a mechanism for determining a potential assignments of outbound trains to production tracks, which may serve to maintain the operational continuity and efficiency of the system described herein.

In embodiments, unit diffusion manager 122 may obtain the identification of customers associated with units arriving at the hub (e.g., the unit arriving at the hub at step 310) from unit-customer manager 328. In embodiments, unit-customer manager 328 may obtain information such as an identification of a customer to which a unit belongs, an indication of a parking lot category or parking lot preference by the customer, etc. In embodiments, unit diffusion manager 122 may use this information to determine which customer the unit (the unit arriving at block 310) belongs to. Unit diffusion manager 122 may determine other units (e.g., other units arriving at the hub over the planning horizon of optimized operating schedule 330) that may also belong to the same customer and may (e.g., based on the parking lot preference indication) assign a parking spot to the unit (and to the other units also assigned to the same outbound train) within the preferred parking lot or parking lot category configured to minimize the time it may take to move the units from their respectively assigned parking spot to the customer transport vehicle that may take the units out of the hub, maximizing the unit throughput over the planning horizon of optimized operating schedule 330.

In embodiments, unit diffusion manager 122 may be configured to, based on the unit characteristics of the unit received at block 310, assign a parking spot to the unit within the assigned parking lot having the allocated parking lot category that is determined based on intelligently diffusing other units (e.g., other unis having similar unit characteristics, such as belonging to a same customer or being assigned to a same outbound train) across the parking spots of the assigned parking lot having the allocated parking lot category such as to minimize the time it may take to move the units from their respectively assigned parking spot to the outbound train for loading. In the case of the units belonging to a same customer and being processed through the IB flow, unit diffusion manager 122 may be configured to, based on the unit characteristics of the unit received at block 310, assign a parking spot to the unit within the assigned parking lot having the allocated parking lot category that is determined based on intelligently diffusing other units (e.g., other unis belonging to a same customer) across the parking spots of the assigned parking lot having the allocated parking lot category such as to minimize the time it may take to move the units from their respectively assigned parking spot to the customer transport vehicle that may take the units out of the hub.

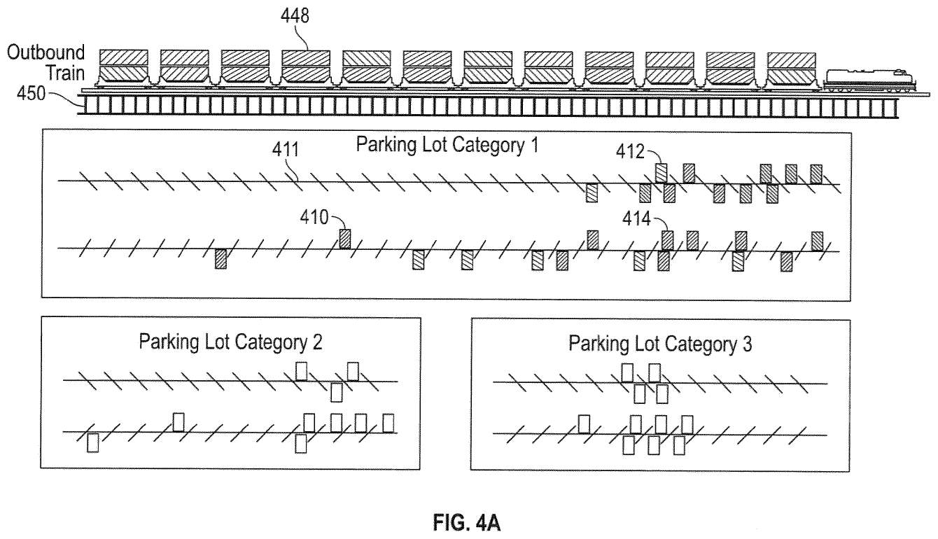

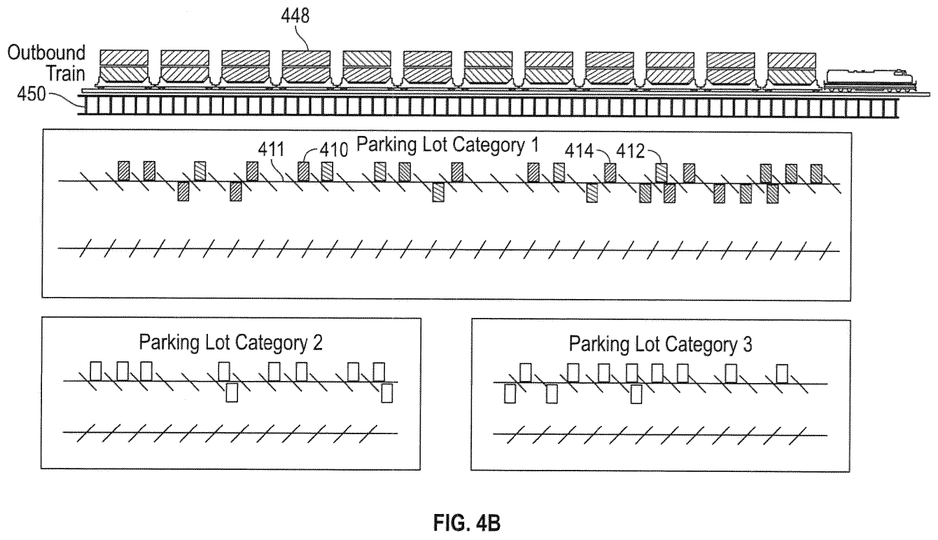

For example, FIG. 4A shows an example of operations for assigning parking spots to units within a hub without intelligent unit diffusion. In this particular example, which is provided to illustrate a distribution or scattering of units through parking lot resources without intelligent unit diffusion, the units may be scattered about the parking lots without consideration as to the orientation or location of the outbound train 448 and/or production train 450. In this example, the units visible within parking lot category 1 (e.g., which may include or more physical parking lots having a parking lot category 1), which include unit 410 representing the unit arriving at block 410 of FIG. 3, may be placed within parking lot category 1. In this example, the visible units within parking lot category 1 may all be assigned to outbound train 448. Outbound train 448 may be assigned to production track 450 to be loaded with the units. In this example, although the visible units within parking lot category 1 may be allocated to parking lot category 1, the parking spot assignments of the visible units may not be based on further considerations, but rather may be based on available capacity. In this case, as can be seen, the visible units may be assigned to parking spots within a general area of parking lot category 1. However, as will be appreciated, when loading of train 448 is underway, due to the compressed distribution of the visible units within a general area, hostlers moving these units to train 448 may encounter a congested environment, and the unit throughput may be reduced as the speed of the hostlers may be limited due to the congestion. Furthermore, hostlers moving these units may have to drive long distances as, for example, after a unit has been loaded onto train 448, the hostler may have to drive all the way back to where the next unit to be loaded may be parked. For example, unit 412 may be relatively close to train 448 (in fact unit 412 is parked in a parking spot that is minimally distant from train 448), while unit 414, while in the same general area as unit 412, may be further way from train 448. A hostler may have to drive from train 448 all the way back to the second row of parking lot category 1 to pick up unit 414 and move it to train 448, and this drive time may increase the overall time for loading train 448, decreasing the unit throughout of the hub and affecting efficiency.

In this example, unit 410 may be assigned to an available spot, without consideration as to which outbound train unit 410 may be assigned to (or is likely to be assigned to), the production track to which the outbound train may be assigned, and/or the orientation of the parking spot with respect to the production track. This may result in a parking spot assignment for unit 410 that is not optimum. For example, as can be seen in example 4A, unit 410 may be assigned to parking spot 413, which is less than optimum (e.g., is not as optimally close to production track 450), especially when considering that parking spot 411 is available and is closer to production track 450 where train 448 is to be built.

In this example, the same scattered and random parking spot assignment is implemented in the parking spot assignment of the visible units in parking lot category 2 and parking lot category 3, creating the same problems as with parking lot category 1.

To solve the issues exemplified in FIG. 4A, unit diffusion manager 122 may be configured with the intelligent unit diffusion functionality described herein. FIG. 4B shows an example of operations for assigning parking spots to units within a hub using intelligent unit diffusion in accordance with embodiments of the present disclosure. As shown in FIG. 4B, the parking spot assignments of the visible units within parking lot category 1 are now implemented with intelligent unit diffusion, which consider the unit-train assignment of the units, the train-track assignment of the outbounds trains, and/or the location and/or orientation of the parking spots with respect to the production tracks to which the outbound train may be assigned when assigning the parking spots to the units to ensure that the parking spot assignments of the units are such that the time it may take to move the units from their respectively assigned parking spot to the production track in which the outbound train is to be loaded is minimized, maximizing the unit throughput over the planning horizon of the optimized operating schedule.

For example, as shown in FIG. 4B, the visible units within parking lot category 1 may be intelligently spread across parking spots within the parking lot category 1 such that the distance between these units and production track 450, to which outbound train 448 may be assigned, may be minimized for a maximum number of these units (e.g., based on consideration of the entire optimized operating schedule over the entire planning horizon). In this case, due to the intelligent spread of the units, the distribution of the units within parking lot category 1 is not as compressed as it may be without intelligent diffusion (e.g., as illustrated in FIG. 4A). As such, when loading of train 448 is underway, hostlers moving these units to train 448 may encounter a clear and uncongested environment, and the unit throughput may be increased as the speed of the hostlers may be increased. Furthermore, hostlers moving these units may not have to drive long distances as most of the intelligently diffused units may be closed to the production track. For example, after a unit has been loaded onto train 448, the hostler may have a short (e.g., optimized or minimized) distance to drive to retrieve the next unit to be loaded. For example, unit 412 may be relatively close to train 448 and a hostler may not have to drive long to retrieve and load unit 412 onto train 448. Once unit 412 is loaded onto train 448, the hostler may not have to drive long to retrieved unit 414 and move unit 414 to production track 450 to load unit 414 onto train 448. A similar efficient loading operation may be performed for the other intelligently diffused units to be loaded onto train 448, which may result in a higher throughput than if the units were assigned to parking spots without intelligent unit diffusion. In this example, with intelligent unit diffusion implemented, unit 410 may be assigned to parking spot 411.

In this example, intelligent unit diffusion may be implemented in the parking spot assignments of the visible units in parking lot category 2 and parking lot category 3, resulting in the same advantageous result described above with respect to parking lot category 1.

It is noted that when a set of units determined to be assigned to a same outbound train are intelligently diffused in accordance with embodiments of the present disclosure, the result is not necessarily that all the units in the set of units are assigned to parking spots with a minimal distance (e.g., closest) to the production track to which the outbound train is assigned. For example, in some cases, some units of the set of units may be assigned to parking spots that are farther away from the production track than the parking spots to which other units of the set of units may be assigned. This is because, when implementing intelligent unit diffusion, unit diffusion manager 122 may consider the entire optimized operating schedule over the entire planning horizon, which may indicate that other units that may arrive at other time increments may be assigned to outbound trains that may be forecasted or scheduled to be consolidated in the same production track (e.g., production track 450). As such, unit diffusion manager 122 may make determinations as to whether some parking spots may be reserved to units assigned to other outbound trains, whether assigning some units in the current set of units to farther away spots may result in a higher unit throughput over the planning horizon (even if the current loading operations of the current set of units may take longer), etc., when determining the diffusion layout or pattern for the current set of units.

For example, in embodiments, DSRO system 160 may predict the number of and/or which trains may arrive at some particular area of the hub and/o may be assigned to a particular production track. In these cases, unit diffusion manager 122 may intelligently diffuse the units not only based on the train currently occupying the area or the production track or the current units being loaded, but may also consider the predictions of the trains arriving in the future, and to unit diffusion manager 122 may determine to spread the units accordingly, potentially leaving some parking spots within the parking lot empty for units assigned to the trains predicted to arrive in the future. In embodiments, unit diffusion manager 122 may also consider the parking spot capacity of the parking lot and may ensure that the unit diffusion may result in an optimized or maximized unit throughput within the hub over the planning horizon of the optimized operating schedule.

In embodiments, unit diffusion manager 122 may be configured to determine a number of units that may be expected to arrive at each increment of the planning horizon. This may be accomplished by leveraging functionality of DSRO system 160 to provide a prediction of the traffic flow through the IB flow and the IG flow. The predicted traffic flow may include a prediction of the number of units that may be expected at each time increment of the planning horizon of the optimized operating schedule. In addition to the number of units, the predicted traffic flow may also predict the type of unit to arrive (e.g., long dwelling, short dwelling, etc.), the customer associated with each of the units expected to arrive, the destination of the unit, the likely outbound train to which each of the units may be assigned, etc. With this information, unit diffusion manager 122 may determine a number of parking spots that may be required to intelligently diffuse the units as they are allocated to parking lot categories.

In embodiments, unit diffusion manager 122 may be configured to implement the intelligent unit diffusion described herein with consideration as to the length of the outbound train (e.g., outbound train 448). For example, unit diffusion manager 122 may determine the number of train cars to be included in outbound train 448, the length and/or capacity of each train car, and may determine the length of outbound train 448. Unit diffusion manager 122 may determine to limit the spread or diffusion of the units along the length of outbound train 448 and within the bounds of the ends of the length of outbound train 448. In this manner, more than one unit of the units assigned to outbound train 448 may be loaded onto outbound train 448 concurrently.

In embodiments, unit diffusion manager 122 may apply the intelligent unit diffusion to the parking lot allocation recommendations of the optimized operating schedule in real-time, such as during operations (e.g., during execution of the optimized operating schedule) when a parking spot request for a unit is received by operations server 125 and routed to unit diffusion manager 122. At this point, unit diffusion manager 122 may assign a parking spot to the unit based on the parking lot allocation recommendation by applying the intelligent unit diffusion to the parking lot allocation recommendations. This functionality may allow a system to consider the real-time current operational environment of the hub, such as current actual parking spot capacity, actual available parking spots in a parking lot category (as operators may not follow the parking lot allocation recommendations), actual train schedules (as some trains may not arrive/depart on schedule), etc.

In alternative or additional embodiments, unit diffusion manager 122 may apply the intelligent unit diffusion to the parking lot allocation recommendations of the optimized operating schedule before the execution of the optimized operating schedule. In these embodiments, unit diffusion manager 122 may apply the intelligent unit diffusion to the parking lot allocation recommendations in the optimized operating schedule, and may generate parking spot assignment recommendations that may be included in the optimized operating schedule to manage the parking spot assignments during execution of the optimized operating schedule. During operations, when a parking spot request for a unit is received by operations server 125, the unit may be assigned a parking spot based on the parking spot assignments recommendations in the optimized operating schedule, which may be based on intelligent unit diffusion based on the destination of the unit and/or the unit-train assignment of the unit.

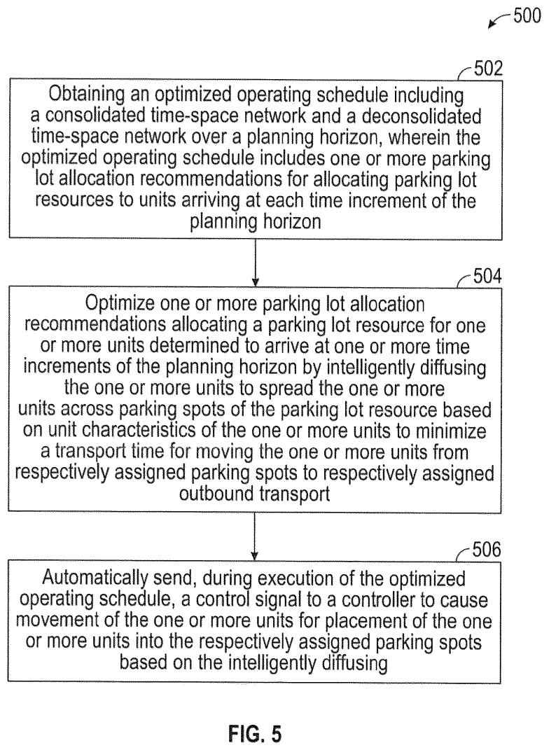

FIG. 5 shows a high-level flow diagram 500 of operation of a system configured for providing functionality for intelligently diffusing unit storage across parking lot resources to maximize unit throughput in a hub based on a DSRO in accordance with embodiments of the present disclosure. For example, the functions illustrated in the example blocks shown in FIG. 5 may be performed by system 100 of FIG. 1 according to embodiments herein. In embodiments, the operations of the method 500 may be stored as instructions that, when executed by one or more processors, cause the one or more processors to perform the operations of the method 500.

At block 502, an optimized operating schedule including a consolidated time-space network and a deconsolidated time-space network over a planning horizon is obtained. In embodiments, the optimized operating schedule includes one or more parking lot allocation recommendations for allocating parking lot resources to units arriving at each time increment of the planning horizon. In embodiments, functionality of an operations server (e.g., operations server 125 as illustrated in FIGS. 1-3) may be used to obtain an optimized operating schedule including a consolidated time-space network and a deconsolidated time-space network over a planning horizon. In embodiments, the operations server may perform operations to obtain an optimized operating schedule including a consolidated time-space network and a deconsolidated time-space network over a planning horizon according to operations and functionality as described above with reference to operations server 125 and as illustrated in FIGS. 1-4B.

At block 504, one or more parking lot allocation recommendations allocating a parking lot resource for one or more units determined to arrive at one or more time increments of the planning horizon are optimized by intelligently diffusing the one or more units to spread the one or more units across parking spots of the parking lot resource based on unit characteristics of the one or more units to minimize a transport time for moving the one or more units from respectively assigned parking spots to respectively assigned outbound transport. In embodiments, functionality of a unit diffusion manager (e.g., unit diffusion manager 122 as illustrated in FIGS. 2 and 3) may be used to optimize one or more parking lot allocation recommendations allocating a parking lot resource for one or more units determined to arrive at one or more time increments of the planning horizon by intelligently diffusing the one or more units to spread the one or more units across parking spots of the parking lot resource based on unit characteristics of the one or more units to minimize a transport time for moving the one or more units from respectively assigned parking spots to respectively assigned outbound transport. In embodiments, the unit diffusion manager may perform operations to optimize one or more parking lot allocation recommendations allocating a parking lot resource for one or more units determined to arrive at one or more time increments of the planning horizon by intelligently diffusing the one or more units to spread the one or more units across parking spots of the parking lot resource based on unit characteristics of the one or more units to minimize a transport time for moving the one or more units from respectively assigned parking spots to respectively assigned outbound transport according to operations and functionality as described above with reference to unit diffusion manager 122 and as illustrated in FIGS. 1-4B.

At block 506, a control signal is automatically sent to a controller to cause movement of the one or more units for placement of the one or more units into the respectively assigned parking spots based on the intelligently diffusing during execution of the optimized operating schedule. In embodiments, functionality of an operations server (e.g., operations server 125 as illustrated in FIGS. 1-3) may be used to automatically send, during execution of the optimized operating schedule, a control signal to a controller to cause movement of the one or more units for placement of the one or more units into the respectively assigned parking spots based on the intelligently diffusing. In embodiments, the operations server may perform operations to automatically send, during execution of the optimized operating schedule, a control signal to a controller to cause movement of the one or more units for placement of the one or more units into the respectively assigned parking spots based on the intelligently diffusing according to operations and functionality as described above with reference to operations server 125 and as illustrated in FIGS. 1-4B.

Persons skilled in the art will readily understand that advantages and objectives described above would not be possible without the particular combination of computer hardware and other structural components and mechanisms assembled in this inventive system and described herein. Additionally, the algorithms, methods, and processes disclosed herein improve and transform any general-purpose computer or processor disclosed in this specification and drawings into a special purpose computer programmed to perform the disclosed algorithms, methods, and processes to achieve the aforementioned functionality, advantages, and objectives. It will be further understood that a variety of programming tools, known to persons skilled in the art, are available for generating and implementing the features and operations described in the foregoing. Moreover, the particular choice of programming tool(s) may be governed by the specific objectives and constraints placed on the implementation selected for realizing the concepts set forth herein and in the appended claims.

The description in this patent document should not be read as implying that any particular element, step, or function can be an essential or critical element that must be included in the claim scope. Also, none of the claims can be intended to invoke 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” “processing device,” or “controller” within a claim can be understood and intended to refer to structures known to those skilled in the relevant art, as further modified or enhanced by the features of the claims themselves, and can be not intended to invoke 35 U.S.C. § 112(f). Even under the broadest reasonable interpretation, in light of this paragraph of this specification, the claims are not intended to invoke 35 U.S.C. § 112(f) absent the specific language described above.

The disclosure may be embodied in other specific forms without departing from the spirit or essential characteristics thereof. For example, each of the new structures described herein, may be modified to suit particular local variations or requirements while retaining their basic configurations or structural relationships with each other or while performing the same or similar functions described herein. The present embodiments are therefore to be considered in all respects as illustrative and not restrictive. Accordingly, the scope of the disclosure can be established by the appended claims. All changes which come within the meaning and range of equivalency of the claims are therefore intended to be embraced therein. Further, the individual elements of the claims are not well-understood, routine, or conventional. Instead, the claims are directed to the unconventional inventive concept described in the specification.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various embodiments of the present disclosure may be combined or performed in ways other than those illustrated and described herein.

Functional blocks and modules in FIGS. 1-4B may comprise processors, electronics devices, hardware devices, electronics components, logical circuits, memories, software codes, firmware codes, etc., or any combination thereof. Consistent with the foregoing, various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal, base station, a sensor, or any other communication device. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods, and steps described in the specification. As one of ordinary skill in the art will readily appreciate from the disclosure of the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method of intelligently diffusing units across parking lot resources of a hub, comprising:
obtaining an optimized operating schedule including a consolidated time-space network and a deconsolidated time-space network over a planning horizon, wherein the optimized operating schedule includes one or more parking lot allocation recommendations for allocating parking lot resources to units arriving at each time increment of the planning horizon;
optimizing one or more parking lot allocation recommendations allocating a parking lot resource to one or more units determined to arrive at one or more time increments of the planning horizon by intelligently diffusing the one or more units to spread the one or more units across parking spots of the parking lot resource based on unit characteristics of the one or more units to minimize a transport time for moving the one or more units from respectively assigned parking spots to respectively assigned outbound transport; and
automatically sending, during execution of the optimized operating schedule, a control signal to a controller to cause movement of the one or more units for placement of the one or more units into the respectively assigned parking spots based on the intelligently diffusing.

2. The method of claim 1, wherein the parking lot resources includes one or more of:
physical parking lots of the hub; and
parking lot categories of the physical parking lots of the hub.

3. The method of claim 1, wherein an outbound transport assigned to a unit includes one or more of:
an outbound train to which the unit is assigned for transportation to a destination of the unit; and
a customer transport for picking up unit and removing the unit from the hub for the customer.

4. The method of claim 1, wherein intelligently diffusing the one or more units includes:
determining a unit-train assignment for each of the one or more units to determine an outbound train to which the one or more units is to be assigned;
determining a train-track assignment for the outbound train to which the one or more units is to be assigned to determine a production track in which the outbound train is to be loaded with the one or more units; and
spreading the one or more units across parking spots of the parking lot resource based on the unit-train assignment for each of the one or more units and the train-track assignment for the outbound train such that the transport time for moving the one or more units from the respectively assigned parking spots of each of the one or more units to the outbound train is minimized and the unit throughput of the hub is maximized.

5. The method of claim 4, wherein determining the unit-train assignment for each of the one or more units includes one or more of:
determining the unit-train assignment for each of the one or more units based on information from one or more active train schedules covering the planning horizon associated with the hub; and
determining the unit-train assignment for each of the one or more units based on historical data including past train arrival events and train departure events associated with the hub.

6. The method of claim 4, further comprising:
determining a length of the outbound train to which the one or more units is to be assigned.

7. The method of claim 6, wherein intelligently diffusing the one or more units includes:
spreading the one or more units across parking spots of the parking lot resource along the length of the outbound train, wherein each parking post assigned to the one or more units falls within the length of the outbound train.

8. The method of claim 1, wherein intelligently diffusing the one or more units includes:
determining an identification of a customer associated with the one or more units;
determining a parking lot preference associated with the customer based on the identification; and
spreading the one or more units across parking spots of the parking lot resource based on the parking lot preference associated with the customer such that the transport time for extracting the one or more units from the respectively assigned parking spots of each of the one or more units to an exterior of the hub is minimized and the unit throughput of the hub is maximized.

9. A system configured for intelligently diffusing units across parking lot resources of a hub, comprising:
at least one processor; and
a memory operably coupled to the at least one processor and storing processor-readable code that, when executed by the at least one processor, is configured to perform operations including:
obtaining an optimized operating schedule including a consolidated time-space network and a deconsolidated time-space network over a planning horizon, wherein the optimized operating schedule includes one or more parking lot allocation recommendations for allocating parking lot resources to units arriving at each time increment of the planning horizon;
optimizing one or more parking lot allocation recommendations allocating a parking lot resource to one or more units determined to arrive at one or more time increments of the planning horizon by intelligently diffusing the one or more units to spread the one or more units across parking spots of the parking lot resource based on unit characteristics of the one or more units to minimize a transport time for moving the one or more units from respectively assigned parking spots to respectively assigned outbound transport; and
automatically sending, during execution of the optimized operating schedule, a control signal to a controller to cause movement of the one or more units for placement of the one or more units into the respectively assigned parking spots based on the intelligently diffusing.

10. The system of claim 9, wherein the parking lot resources includes one or more of:
physical parking lots of the hub; and
parking lot categories of the physical parking lots of the hub.

11. The system of claim 9, wherein an outbound transport assigned to a unit includes one or more of:
an outbound train to which the unit is assigned for transportation to a destination of the unit; and
a customer transport for picking up unit and removing the unit from the hub for the customer.

12. The system of claim 9, wherein intelligently diffusing the one or more units includes:
determining a unit-train assignment for each of the one or more units to determine an outbound train to which the one or more units is to be assigned;
determining a train-track assignment for the outbound train to which the one or more units is to be assigned to determine a production track in which the outbound train is to be loaded with the one or more units; and
spreading the one or more units across parking spots of the parking lot resource based on the unit-train assignment for each of the one or more units and the train-track assignment for the outbound train such that the transport time for moving the one or more units from the respectively assigned parking spots of each of the one or more units to the outbound train is minimized and the unit throughput of the hub is maximized.

13. The system of claim 12, wherein determining the unit-train assignment for each of the one or more units includes one or more of:
determining the unit-train assignment for each of the one or more units based on information from one or more active train schedules covering the planning horizon associated with the hub; and
determining the unit-train assignment for each of the one or more units based on historical data including past train arrival events and train departure events associated with the hub.

14. The system of claim 12, wherein the operations further comprise:
determining a length of the outbound train to which the one or more units is to be assigned.

15. The system of claim 14, wherein intelligently diffusing the one or more units includes:
spreading the one or more units across parking spots of the parking lot resource along the length of the outbound train, wherein each parking post assigned to the one or more units falls within the length of the outbound train.

16. The system of claim 9, wherein intelligently diffusing the one or more units includes:
determining an identification of a customer associated with the one or more units;
determining a parking lot preference associated with the customer based on the identification; and
spreading the one or more units across parking spots of the parking lot resource based on the parking lot preference associated with the customer such that the transport time for extracting the one or more units from the respectively assigned parking spots of each of the one or more units to an exterior of the hub is minimized and the unit throughput of the hub is maximized.

17. A computer-based tool for intelligently diffusing units across parking lot resources of a hub, the computer-based tool including non-transitory computer readable media having stored thereon computer code which, when executed by a processor, causes a computing device to perform operations comprising:
obtaining an optimized operating schedule including a consolidated time-space network and a deconsolidated time-space network over a planning horizon, wherein the optimized operating schedule includes one or more parking lot allocation recommendations for allocating parking lot resources to units arriving at each time increment of the planning horizon;
optimizing one or more parking lot allocation recommendations allocating a parking lot resource to one or more units determined to arrive at one or more time increments of the planning horizon by intelligently diffusing the one or more units to spread the one or more units across parking spots of the parking lot resource based on unit characteristics of the one or more units to minimize a transport time for moving the one or more units from respectively assigned parking spots to respectively assigned outbound transport; and
automatically sending, during execution of the optimized operating schedule, a control signal to a controller to cause movement of the one or more units for placement of the one or more units into the respectively assigned parking spots based on the intelligently diffusing.

18. The computer-based tool of claim 17, wherein intelligently diffusing the one or more units includes:
determining a unit-train assignment for each of the one or more units to determine an outbound train to which the one or more units is to be assigned;
determining a train-track assignment for the outbound train to which the one or more units is to be assigned to determine a production track in which the outbound train is to be loaded with the one or more units; and
spreading the one or more units across parking spots of the parking lot resource based on the unit-train assignment for each of the one or more units and the train-track assignment for the outbound train such that the transport time for moving the one or more units from the respectively assigned parking spots of each of the one or more units to the outbound train is minimized and the unit throughput of the hub is maximized.

19. The computer-based tool of claim 18, wherein determining the unit-train assignment for each of the one or more units includes one or more of:
determining the unit-train assignment for each of the one or more units based on information from one or more active train schedules covering the planning horizon associated with the hub; and
determining the unit-train assignment for each of the one or more units based on historical data including past train arrival events and train departure events associated with the hub.

20. The computer-based tool of claim 17, wherein intelligently diffusing the one or more units includes:
determining an identification of a customer associated with the one or more units;
determining a parking lot preference associated with the customer based on the identification; and
spreading the one or more units across parking spots of the parking lot resource based on the parking lot preference associated with the customer such that the transport time for extracting the one or more units from the respectively assigned parking spots of each of the one or more units to an exterior of the hub is minimized and the unit throughput of the hub is maximized.
